(19) United States
(12) Patent Application Publication
(10) Pub. No.: US 2025/0117439 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Shahalam BAIG, Rochester, NY (US); Tyler MAIMAN, Melville, NY (US); Joshua EDWARDS, Philadelphia, PA (US); Ian KATZMAN, Herndon, VA (US); Jackson WESTWOOD, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,173

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 16/957; G06F 16/958; H04N 21/4782

(52) U.S. Cl. CPC G06F 16/9577; G06F 16/986; H04N 21/4782

(57) ABSTRACT

A method may include receiving, using a computing device, a first video (FV), the computing device including a first media query (FMQ) associated with a first size (FS) of a viewport and a first rule (FR) and a second media query (SMQ) associated with a second size (SS) of the viewport and a second rule (SR), and the FV being associated with a DRM technology (DRMT) and a first value of an attribute, the first value satisfying the FR. The method may include outputting the viewport at the FS and the FV to a display, the FV being configured to be presented within the viewport outputted to the display. The method may include detecting the SS of the viewport on the display, and transmitting a request for a second video associated with the DRMT and a second value of the attribute, the second value satisfying the SR.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, each of which is incorporated herein by reference in its entirety.

### TECHNICAL FIELD

Various embodiments of this disclosure relate generally to techniques for securing content, and more particularly to systems and methods for securing content of a portal (e.g., a webpage, a website, an application, etc.), while maintaining fidelity of the content using media queries.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, the target may be a user who uses a display screen of a computing device to view a webpage of a bank. More specifically, the user may view the user's checking account balance on the bank's webpage, within a browser window presented on the display screen. A social engineer using another computing device may attempt to persuade the user to reveal the checking account balance to the social engineer using a screensharing application, for example.

To prevent the social engineer from viewing the user's checking account balance during the screensharing, the bank may employ digital rights management (“DRM”) technologies, which are technologies that limit the use of digital content. However, if the user attempts to resize the browser window on the display screen, content of the bank's website that is protected using the DRM technologies (e.g., the user's checking account balance) may appear distorted or cut off on the display screen.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, an application, etc.), while maintaining fidelity of the content using media queries, are disclosed. Each of the examples disclosed herein may include one or more features described in connection with any of the other disclosed examples.

In one aspect, an exemplary embodiment of a method may include receiving, using a browser module of a computing device, a first video from an application server. The browser module may include each of (i) a first media query associated with a first size of a viewport and a first rule and (ii) a second media query associated with a second size of the viewport and a second rule. The first video may be associated with a content element, a digital rights management technology, and a first value of an attribute, the first value satisfying the first rule associated with the first media query. The method may include forming, using the browser module, a HyperText Markup Language (HTML) element including the first video received from the application server. The method may include outputting, using the computing device, the viewport at the first size and the first video of the HTML element to a display screen associated with the computing device. The first video may be configured to be presented within the viewport outputted at the first size to the display screen. The method may include detecting, using the browser module, the second size of the viewport on the display screen. The method may further include, in response to detecting the second size of the viewport, transmitting, using the browser module, a request for a second video associated with the content element, the digital rights management technology, and a second value of the attribute. The second value may satisfy the second rule associated with the second media query.

In a further aspect, an exemplary embodiment of a system may include at least one processor and at least one memory having programming instructions stored thereon, which, when executed by the at least one processor, cause the system to perform operations. The operations may include receiving, using a computing device, a first video from an application server. The computing device may include each of (i) a first media query associated with a first size of a viewport and a first rule and (ii) a second media query associated with a second size of the viewport and a second rule. The first video may be associated with a content element, a digital rights management technology, and a first value of an attribute, the first value satisfying the first rule associated with the first media query. The operations may include forming, using the computing device, an HTML element including the first video received from the application server. The operations may include outputting, using the computing device, the viewport at the first size and the first video of the HTML element to a display screen associated with the computing device. The first video may be configured to be presented within the viewport outputted at the first size to the display screen. The operations may include detecting, using the computing device, the second size of the viewport on the display screen. The operations may include, in response to detecting the second size of the viewport, transmitting, using the computing device, a request for a second video associated with the content element, the digital rights management technology, and a second value of the attribute. The second value may satisfy the second rule associated with the second media query.

In another aspect, an exemplary embodiment of a method may include receiving, using a computing device, a first video from an application server. The computing device may include each of (i) a first media query associated with a first size of a viewport and a first rule and (ii) a second media query associated with a second size of the viewport and a second rule. The first video may be associated with sensitive data, a digital rights management technology, and a first value of an attribute. The first value may satisfy the first rule associated with the first media query. The method may include forming, using the computing device, an HTML element including the first video received from the application server. The method may include outputting, using the computing device, the viewport at the first size and the first video of the HTML element to a display screen associated with the computing device. The first video may be configured to be presented within the viewport outputted at the first size to the display screen. The method may include detecting, using the computing device, the second size of the viewport on the display screen. The method may further include, in response to detecting the second size of the viewport, transmitting, using the computing device, a request for a second video associated with the sensitive data, the digital rights management technology, and a second value of the attribute. The second value may satisfy the second rule associated with the second media query.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2A depicts an example display screen, according to one or more embodiments.

FIG. 2B depicts an example display screen, according to one or more embodiments.

FIG. 3 depicts a flow diagram of an example method, according to one or more embodiments.

FIG. 4 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “content element” may represent content or data such as text data (e.g., letters, numbers, symbols, metadata, or alt text), image data (e.g., an image, a graphic, a sequence of image frames, or a video), or audio data (e.g., a sequence of audio frames). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements.

As used herein, the term “window” may refer to a region on a display screen in which data (e.g., text data, image data, etc.) is presented using one or more pixels. The term “browser window” herein may refer to a window in which a web browser is displayed and through which a user may access and view websites, webpages, web applications, or other content available on the internet. The term “viewport” herein may refer to an area, region, or portion of a webpage or website that is presented within a browser window (or visible to a user viewing the browser window) on a display screen.

As used herein, the term “HTML page” may refer to a file that includes HTML, and that defines the structure and content of a webpage or website. An HTML element may represent a component of an HTML page, and may include, for example, a start tag, an end tag, a content element, or a reference to a content element (e.g., a link, hyperlink, address, or path to a content element). In some embodiments, an HTML element may include one or more HTML elements (e.g., nested HTML elements).

As used herein, the term “Cascading Style Sheet” (also referred to herein as “CSS”) may refer to a language used to describe the presentation (e.g., formatting, layout, sizing, positioning, coloring, etc.) of content of a webpage or website. A “CSS rule” may refer to a rule (or property) that is written in CSS and that, when applied, describes the presentation of content of a webpage or website. In some aspects, one or more CSS rules may be included in a CSS file (e.g., a file with the extension, “.css”), which may be referenced by an HTML page. One or more CSS rules may also be directly included in an HTML page.

As used herein, the term “media query” may refer to a rule or logical expression that is used to conditionally apply one or more CSS rules to content of a webpage or website, based on characteristics or the environment of a device used to output (e.g., display, project, or print) the content. A “logical expression” may refer to a statement that evaluates to true or false (e.g., a Boolean expression). In some aspects, a media query may include a media type and one or more media features, and correspond to one or more CSS rules. A media type refers to a general category of device for which the corresponding one or more CSS rules are intended. For example, a media type may refer to categories such as screen (e.g., a display screen), print (e.g., a printer), projection (e.g., a projector), all (e.g., all suitable devices), or speech (e.g., screenreaders). A media feature refers to a characteristic of a device (e.g., a display screen, printer, projector, or screenreader) or environment of a device (e.g., a condition or setting in which content is presented, projected, or printed). For example, a media feature may refer to one or more of the following: a resolution of a device; an orientation of a device (e.g., portrait or landscape); a width of a viewport; a minimum width of a viewport; a maximum width of a viewport; a height of a viewport; a minimum height of a viewport; a maximum height of a viewport; an aspect ratio (e.g., a width divided by a height) of a viewport; a minimum aspect ratio of a view port; a maximum aspect ratio of a viewport; color (e.g., the number of bits per color component of an output device such as a display screen, projector, or printer); color gamut (e.g., the approximate range of colors that an output device, such as a display screen, projector, or printer, can output); color index (e.g., the number of colors an output device, such as a display screen, projector, or printer, can display); a pointer for a device (e.g., where a course pointer may refer to a finger used to interact with a touch screen display device); a preferred color scheme (e.g., whether a user prefers a light or dark color scheme); or a preferred reduction in motion (e.g., whether a user prefers reduced motion on a webpage or website). Further, a media feature may include one or more breakpoints, where a breakpoint refers to a point or value at which a layout or design of a website may change to adapt to different characteristics or environments of a device, when the media feature (of a media query) is applied. For example, where a media feature specifies a condition where the maximum width of a viewport is 768 pixels, the breakpoint of this media feature is 768 pixels. In some aspects, each of the media type and the one or more media features of a media query may represent a condition, state, characteristic, or quality.

In some aspects, when the media type and the one or more media features of a media query are true for (or match or correspond to) a device on which the media query is stored (or with which the media query is associated), the one or more CSS rules corresponding to the media query may be applied to content output by the device. For example, a media query may specify that for a display screen on which a viewport is presented, when the viewport has a width of at least 768 pixels, a corresponding CSS rule specifying that the background color of the viewport is to be blue, should be applied to the viewport. As another example, a media query may specify that for a display screen on which a viewport is presented, when the display screen has a portrait orientation, a corresponding CSS rule specifying that content in the viewport is to be presented in a columnar format, should be applied to the viewport. As yet another example, a media query may specify that for a display screen on which a viewport is presented, when the viewport has a height of at least 1080 pixels, a corresponding CSS rule specifying that a video presented in the viewport is to have a height of 720 pixels, should be applied to the viewport.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11® or an application accessed using a Print Screen key of a keyboard or keypad).

As used herein, the term “sensitive data” may refer to data that is intended for, or restricted to the use of, one or more users or entities. Sensitive data may represent data that is personal, private, confidential, privileged, secret, classified, or in need of protection. Examples of sensitive data may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; passport information; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense; or data that is copyrighted, etc.

In the following description, embodiments will be described with reference to the accompanying drawings. As will be discussed in more detail below, various embodiments, methods, and systems for securing content of a portal (e.g., a webpage, a website, an application, etc.) while maintaining fidelity of the content using media queries, are described.

In an exemplary use case, a customer of a bank may use a computing device, such as a laptop, to obtain financial information. More specifically, the customer may use a browser window presented on a display screen of the laptop to load a webpage that is associated with the bank, and on which the customer anticipates viewing the customer's checking account balance. The browser window may include a viewport for displaying the webpage. Further, the checking account balance may represent sensitive data, which is data that is intended for, or restricted to the use of, one or more users or entities (e.g., the customer and the bank).

As the webpage is loaded, the laptop may determine that characteristics or an environment of the display screen, such as the size of the viewport, match characteristics or an environment specified in a media query stored on the laptop. The media query may correspond to a CSS rule specifying that (i) the webpage is to be presented in the viewport as an image frame (or video frame) of a DRM-protected video, and (ii) the DRM-protected video is to be presented at a particular size that fits within the viewport. Upon determining the match, the laptop may execute the media query and CSS rule by retrieving the specified DRM-protected video and outputting the retrieved DRM-protected video to the display screen. In some aspects, the DRM-protected video may represent a single-frame video that is configured to be played in a loop. Further, the DRM-protected video may be configured to play only when the display screen of the laptop is not being screenshared or screenshotted. Put differently, the DRM-protected video may be configured to not play (or be blocked from playing) when the display screen of the laptop is being screenshared or screenshotted in order to protect the customer's checking account balance (or other sensitive data included in the webpage) from being shared with a social engineer or potential social engineer.

When the display screen is not being screenshared or screenshotted, the DRM-protected video may play in a loop within the viewport on the display screen, and appear to the customer as a still (or static) image. In some aspects, because the webpage is presented as specified by the CSS rule, the webpage (or the DRM-protected video) may be presented in a clear and user-friendly manner and thereby reflect responsive web design. That is, the webpage (or the DRM-protected video) neatly fits within the viewport, and the checking account balance and any other content included in the webpage do not appear distorted to the customer. Accordingly, the media query, CSS rule, and DRM-protected video may be used secure content of the bank's webpage, while maintaining the fidelity of the content.

While the example above involves a webpage and a checking account balance, it should be understood that techniques according to this disclosure may be adapted to any suitable type of program (e.g., a website, portal, application, browser extension, plugin, etc.) and content (e.g., sensitive data, non-sensitive data, text data, image data, audio data, web applications, etc.), respectively. It should also be understood that the example above is illustrative only. The techniques and technologies of this disclosure may be adapted to any suitable activity.

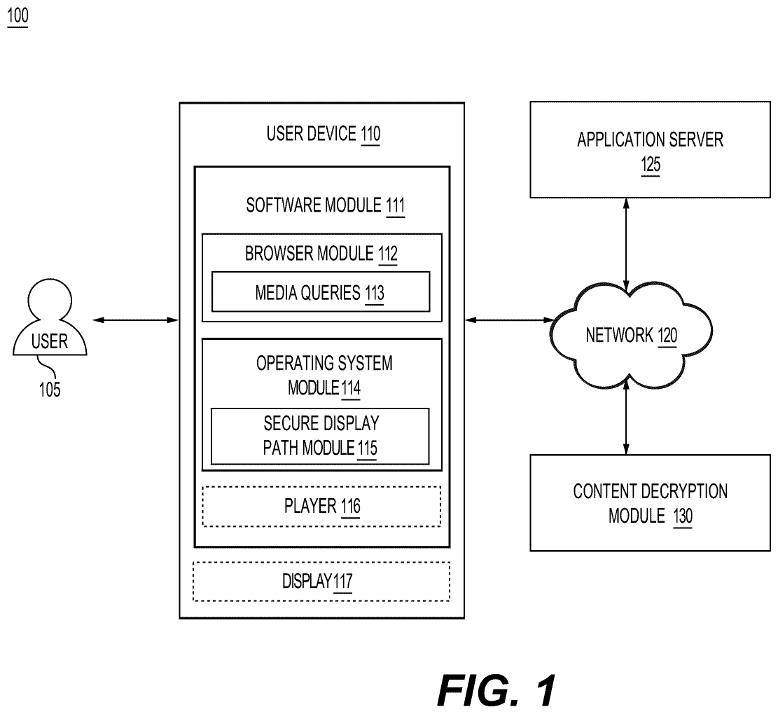

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed Jun. 28, 2024, or (iii) the environment 100 described in U.S. Provisional Application 63/683,063, filed Aug. 14, 2024, where each of these U.S. provisional applications is incorporated by reference herein in its entirety. As shown in FIG. 1, the environment 100 may include a user device 110, a network 120 (e.g., an electronic network), an application server 125, and a content decryption model 130 (also referred to herein as the “CDM 130”). In some aspects, the user device 110, the application server 125, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal (e.g., a webpage, website, or application) accessed using the user device 110.

The user device 110 may be configured to enable the user 105 to access or interact with the network 120, the application server 125, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 114, optionally a player 116, and optionally a display 117.

The player 116 may represent a video player configured to play back one or more videos, or present image frames (or video frames) of one or more videos on a display screen. In some embodiments, the player 116 may be included in the browser module 112 or the operating system module 114 (not shown in FIG. 1). In some other embodiments, the player 116 may represent hardware included in the user device 110 (not shown in FIG. 1). In some embodiments, the player 116 may represent an interactive video player, which is a video player configured to play back a video, where a user (e.g., the user 105) may interact with the video (e.g., by selecting a button presented in the video) during the playback on a display screen.

In some embodiments, the user device 110 may include the display 117, which may represent a display screen configured to display or present data, optionally using the player 116. In some aspects, the display 117 may receive data for display from the browser module 112 or the operating system module 114.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 114, the player 116, the display 117, the network 120, and the application server 125 and the CDM 130, via the network 120. For example, in response to the user 105 inputting a web address (or uniform resource locator) to the browser module 112 (e.g., using the display 117 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage (e.g., an HTML page corresponding to the webpage) from the application server 125 via the network 120. In some aspects, the browser module 112 may be configured to load, render, or output the webpage (or a portion of the webpage) to the display 117, directly or indirectly via the operating system module 114, for display within a viewport of a web browser.

As shown in FIG. 1, the browser module 112 may include one or more media queries 113 (also referred to herein as the “media queries 113”) used to dynamically adjust the design or layout (e.g., the formatting, style, size, positioning, etc.) of content of the webpage (or a portion of the webpage) output to the display 117, for display within the viewport. In some aspects, a media query 113 may be a rule or logical expression that is used to conditionally apply one or more CSS rules to content of the webpage, based on characteristics or the environment of the user device 110 or the display 117. A “logical expression” may refer to a statement that evaluates to true or false (e.g., a Boolean expression). In some embodiments, the browser module 112 may include the media queries 113 by default (e.g., in a CSS file). Further, in some embodiments, the browser module 112 may receive one or more of the media queries 113 (and one or more corresponding CSS rules) from the application server 125. In some aspects, a media query 113 (along with one or more corresponding CSS rules) may be included directly in an HTML page corresponding to the webpage, or a CSS file referenced by the HTML page.

In some aspects, a media query 113 may include a media type and one or more media features, and correspond to (or be associated with) one or more CSS rules. A media type refers to, or specifies, a general category of device (e.g., the user device 110 or the display 117) for which the corresponding one or more CSS rules are intended. For example, a media type may refer to the category such as screen (e.g., the display screen 117), print (e.g., a printer associated with the user device 110), projection (e.g., a projector associated with the user device 110), all (e.g., all suitable devices such as the user device 110 and the display 117), or speech (e.g., a screenreader associated with the user device 110). A media feature may refer to, or specify, a characteristic of a device (e.g., the user device 110 or the display 117) or environment of a device (e.g., a condition or setting in which content is presented using the user device 110 or the display 117). For example, a media feature may specify one or more of the following: a resolution of the display 117; an orientation of the display 117 (e.g., portrait or landscape); a width of a viewport presented on the display 117; a minimum width of the viewport; a maximum width of the viewport; a height of the viewport; a minimum height of the viewport; a maximum height of the viewport; an aspect ratio (e.g., a width divided by a height) of the viewport; a minimum aspect ratio of the view port; a maximum aspect ratio of the viewport; color (e.g., the number of bits per color component of the display 117); color gamut (e.g., the approximate range of colors that the display 117 can output); color index (e.g., the number of colors the display 117 can display); a preferred color scheme (e.g., whether the user 105 prefers a light or dark color scheme); or a preferred reduction in motion (e.g., whether the user 105 prefers reduced motion on a webpage or website).

In some embodiments, the browser module 112 may be configured to dynamically (or continuously) determine whether one or more of the media queries 113 evaluate to true. Put differently, the browser module 112 may be configured to dynamically (or continuously) determine whether one or more of the media queries 113 include both a media type and media feature(s) that match or correspond to characteristics or environments of the user device 110 (or the display 117). Upon determining such a match, the browser module 112 may be configured to apply the CSS rule(s) associated with the one or more matching media queries 113 to content of the webpage presented in a viewport of a web browser on the display 117. In some embodiments, in order to apply the CSS rule(s) associated with the one or more matching media queries 113, the browser module 112 may transmit (e.g., dynamically), to the application server 125, a request for one or more content elements of the webpage that would satisfy (or conform or be compatible with) the CSS rule(s) to be applied. For example, where a CSS rule to be applied requires a video of a webpage to have a particular aspect ratio or resolution, the browser module 112 would transmit (e.g., dynamically) a request for such a video to the application server 125. Upon receiving the video from the application server 125 (e.g., via the CDM 130), the browser module 112 would dynamically output the video to the display 117 to apply the CSS rule. In some aspects, by applying the CSS rules of the one or more matching media queries 113 to the content of the webpage displayed in the viewport, the content of the webpage may be presented in an optimal or user friendly manner (e.g., not distorted or cutoff by the viewport).

In some embodiments, the browser module 112 may be configured to monitor for changes to characteristics or environments of the user device 110 (or the display 117). Further, the browser module 112 may be configured to monitor for (or identify) particular characteristics or environments of the user device 110 (or the display 117) that match or correspond to one or media features of the media queries 113. For example, the browser module 112 may be configured to monitor for changes to, or particular value(s) or state(s) of, one or more of the following: a resolution of the display 117; an orientation of the display 117 (e.g., portrait or landscape); a width of a viewport presented on the display 117; a height of the viewport; an aspect ratio (e.g., a width divided by a height) of the viewport; color (e.g., the number of bits per color component of the display 117); color gamut (e.g., the approximate range of colors that the display 117 can output); color index (e.g., the number of colors the display 117 can display); a preferred color scheme (e.g., whether the user 105 prefers a light or dark color scheme); or a preferred reduction in motion (e.g., whether the user 105 prefers reduced motion on a webpage or website).

Further, the browser module 112 may be configured to determine (or predict) that or more media queries 113 are likely to evaluate to true (e.g., based on the monitoring). For example, where the user 105 uses a mouse associated with the user device 110 to enlarge the viewport in which the webpage is presented on the display 117, the browser module 112 may predict one or more sizes to which the viewport will likely be enlarged (e.g., based on the speed, acceleration, or direction of the mouse or a cursor on the display 117 that is controlled by the mouse). The browser module 112 may also predict one or more media queries 113 that would evaluate to true for the predicted one or more sizes (e.g., where each of the predicted one or more media queries 113 may include a breakpoint that corresponds to a respective one of the predicted one or more sizes). In some embodiments, each of the one or more predicted media queries 113 may be associated with one or more CSS rules that govern (or specify) the presentation of content of the webpage in the viewport at a respective one of the predicted one or more sizes. In some embodiments, the browser module 112 may be configured to predict the one or more sizes once the user 105 begins to enlarge the viewport or while (e.g., continuously or at discrete times when) the user 105 enlarges the viewport. Further, in some embodiments, the browser module 112 may be configured to predict (or determine) that a media query 113 is likely to evaluate to true based on detecting a change to a characteristic or environment of the user device 110 (or the display 117), where the detected change is within a threshold distance or threshold similarity of a breakpoint of the predicted media query 113. Further, the browser module 112 may be configured to transmit (e.g., dynamically), to the application server 125, a request for one or more content elements of the webpage that would satisfy (or conform or be compatible with) the CSS rules of the predicted one or more media queries 113.

In some aspects, and as explained above, when the browser module 112 receives a webpage from the application server 125, the webpage may include (or represent) one or more content elements. In some aspects, a content element may represent content or data such as text data (e.g., letters, numbers, symbols, metadata, or alt text), image data (e.g., an image, a graphic, a sequence of image frames, or a video), or audio data (e.g., a sequence of audio frames). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive data or non-sensitive data. As explained above, sensitive data may refer to data that is intended for, or restricted to the use of, one or more users or entities (e.g., the user 105 and an organization associated with the application server 125). Moreover, sensitive data may represent data that is personal, private, confidential, privileged, secret, classified, or in need of protection. Sensitive data may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; passport information, medical information such as a patient's medical history, a doctor's summary or diagnosis, or medical test results; academic information such as a student's grades or transcript; business information such as trade secrets, proprietary information, or business strategy information;

governmental information such as classified or secret information related to national security or defense; or data that is copyrighted, etc.

In some embodiments, the browser module 112 may be configured to determine whether one or more content elements of the webpage include sensitive data. The browser module 112 may also be configured to transmit this determination to the application server 125 via the network 120. In some embodiments, the browser module 112 may be configured to receive one or more content elements of the webpage from the application server 125, optionally via the CDM 130. For example, the browser module 112 may be configured to receive a DRM-protected video that includes an image frame (or video frame) depicting the one or more content elements of the webpage, from the application server 125 via the CDM 130. The browser module 112 may also be configured to communicate with the operating system module 114 (e.g., a secure display path module 115). For example, the browser module 112 may be configured to transmit one or more content elements (e.g., a DRM-protected video or other data) to the operating system module 114 (e.g., the secure display path module 115).

In some embodiments, the operating system module 114 may include one or more operating systems. In some aspects, an operating system may represent software configured to (i) manage hardware and software resources of the user device 110 or (ii) provide services for applications associated with the user device 110. Further, the operating system module 114 may be configured to communicate with the browser module 112, the player 116, the display 117, and the application server 125 and the CDM 130, via the network 120. In some embodiments, the operating system module 114 may include the secure display path module 115 (also referred to herein as the “secure display path 115”). In some aspects, the secure display path 115 may represent (or include) one or more DRM technologies (or DRM functions) used to protect or secure content element(s) that the secure display path 115 receives (or retrieves) from the browser module 112, the application server 125, or the CDM 130. The secure display path 115 may be native (or specific) to a respective operating system of the operating system module 114. In some embodiments, the secure display path 115 may represent Microsoft's Protected Media Path, for example.

In some aspects, the secure display path module 115 may be configured to load, render, or output to the display 117, one or more content elements of a webpage for presentation, optionally while the browser module 112 concurrently loads, renders, or outputs to the display 117, the remainder (or a portion of) of the webpage for presentation. For example, where a content element of a webpage represents a DRM-protected video that includes an image frame depicting sensitive data (e.g., a checking account balance), the secure display path module 115 may load, render, or output the DRM-protected video to the display 117 for presentation in a viewport, while the browser module 112 concurrently loads, renders, or outputs to the display 117, the remainder (or a portion) of the webpage (e.g., a portion of the webpage that excludes the DRM-protected video and the sensitive data) for presentation in the viewport. In some embodiments, the DRM-protected video may be presented over background color(s) of the remainder (or a portion) of the webpage presented in the viewport, on the display 117. As another example, where a first content element of a webpage represents a DRM-protected video that includes an image frame that is transparent (and does not depict or represent sensitive data) and where a second content element of the webpage represents sensitive data (e.g., a checking account balance), the secure display path module 115 may load, render, or output the first and second content elements to the display 117 for presentation in a viewport, while the browser module 112 loads, renders, or outputs to the display 117, the remainder (or a portion) of the webpage for presentation in the viewport. In some aspects, the first content element (the DRM-protected video) may be presented on top of (or be overlaid on) the second content element (the sensitive data), which may be overlaid on the remainder (or a portion) of the webpage presented in the viewport. Further, when the first content element (the DRM-protected video) is played on the display 117 (e.g., when the transparent image frame of the DRM-protected video is played in a loop), the user 105 may view the second content element (the sensitive data) presented under the first content element on the display 117. As used herein, the terms “image frame that is transparent” and “transparent image frame” refer to an image frame of a video, where the image frame is clear (e.g., see-through or invisible, from the perspective of a user viewing the image frame on the display 117), and does not depict or represent any sensitive data. As yet another example, where a content element of a webpage represents a DRM-protected video that includes an image frame that depicts the entire webpage, the secure display path module 115 may load, render, or output the content element to the display 117 for presentation within a viewport.

In some aspects, the secure display path 115 may be configured to protect (or secure) one or more content elements (e.g., one or more pre-determined or pre-selected content elements) by blocking or preventing the one or more content elements from being loaded, rendered, or output to or played on the display 117, when the display 117 is being screenshared (e.g., using a remote desktop application or screensharing) or screenshotted (e.g., using a screenshotting application). Further, the secure display path 115 may be configured to load, render, output to, or support the playing of (e.g., using the player 116), one or more content elements on the display 117 when the display 117 is not being screenshared or screenshotted.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc. In some aspects, the application server 125 may be configured to communicate with the user device 110 and the CDM 130, via the network 120.

For example, the application server 125 may be configured to transmit an HTML page (or file) corresponding to a webpage to the browser module 112 or the operating system module 114, via the network 120. In some embodiments, the application server 125 may be configured to receive a notification (or determination) from the browser module 112 that one or more content elements of the HTML page include sensitive data. Further, in some embodiments, the application server 125 may be configured to determine whether one or more content elements of the HTML page (or webpage) include sensitive data. In response to determining (or receiving a determination) that a content element includes sensitive data, the application server 125 may generate and encrypt a DRM-protected video that includes either (i) a transparent image frame configured to be presented over the sensitive data on the display 117 or (ii) an image frame that depicts or represents the sensitive data. In some aspects, the application server 125 may be configured to transmit the encrypted, DRM-protected video to the CDM 130 (which may decrypt the encrypted DRM-protected video and transmit the decrypted DRM-protected video to the user device 110).

Further, in some aspects, the application server 125 may be configured to receive one or more requests for one or more content elements of a webpage from the browser module 112 (e.g., where the one or more content elements may be needed by the browser module 112 to apply one or more CSS rules). In some embodiments, in response to receiving, from the browser module 112, a request for a content element that represents, for example, a DRM-protected video that includes an image frame depicting sensitive (or non-sensitive) data, where the resolution of the DRM-protected video and the formatting of the sensitive (or non-sensitive) data conform with a CSS rule, the application server 125 may be configured to generate (or retrieve) such a video. The application server 125 may also be configured to transmit (e.g., via the CDM 130) the video to the browser module 112 for dynamic loading to the display 117 (e.g., via the secure display path 115). Further, in some embodiments, and in response to receiving, from the browser module 112, a request for multiple content elements, such as multiple DRM-protected videos, where each of the multiple DRM-protected videos has a respective aspect ratio that conforms with a respective CSS rule of a respective media query 113, the application server 125 may be configured to generate (or retrieve) such videos either in parallel or in series. The application server 125 may be further configured to (i) transmit one of the generated (or retrieved) videos (e.g., a DRM-protected video that conforms with a CSS rule of an operative media query 113) to the browser module 112 for dynamic loading to the display 117 and (ii) store (e.g., in the application server 125 or elsewhere on the network 120) the remainder of the generated (or retrieved) videos in case such videos are needed by the browser module 112 for future use. Alternatively, the browser module 112 may be configured to transmit at least two (or all of) the generated (or retrieved) videos to the browser module 112 for pre-loading or dynamic loading to the display 117.

In some aspects, the CDM 130 (or DRM platform 130) may be configured to communicate with the user device 110 and the application server 125, via the network 120. For example, the CDM 130 may be configured to receive an encrypted, DRM-protected video from the application server 125. The CDM 130 may also be configured to decrypt the encrypted, DRM-protected video, and transmit the decrypted, DRM-protected video to the user device 110 (e.g., to the browser module 112 or the operating system module 114).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like.

Although depicted as separate components in FIG. 1, it should be understood that a component or portion of a component in the environment 100 may, in some embodiments, be integrated with or incorporated into one or more other components. For example, in some embodiments, at least a portion of the application server 125 or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application servers 125, or multiple CDMs 130.

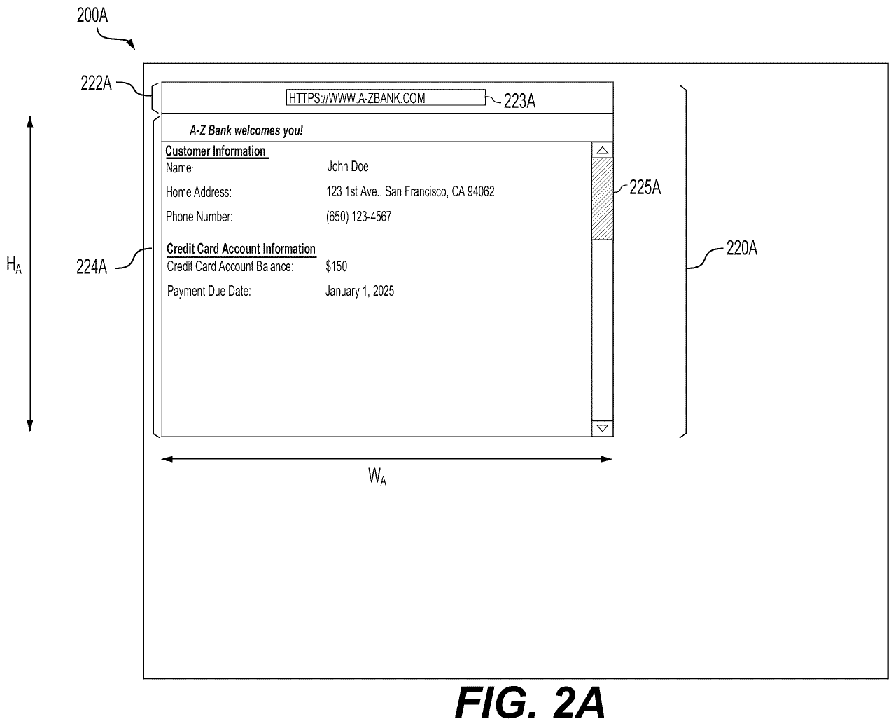

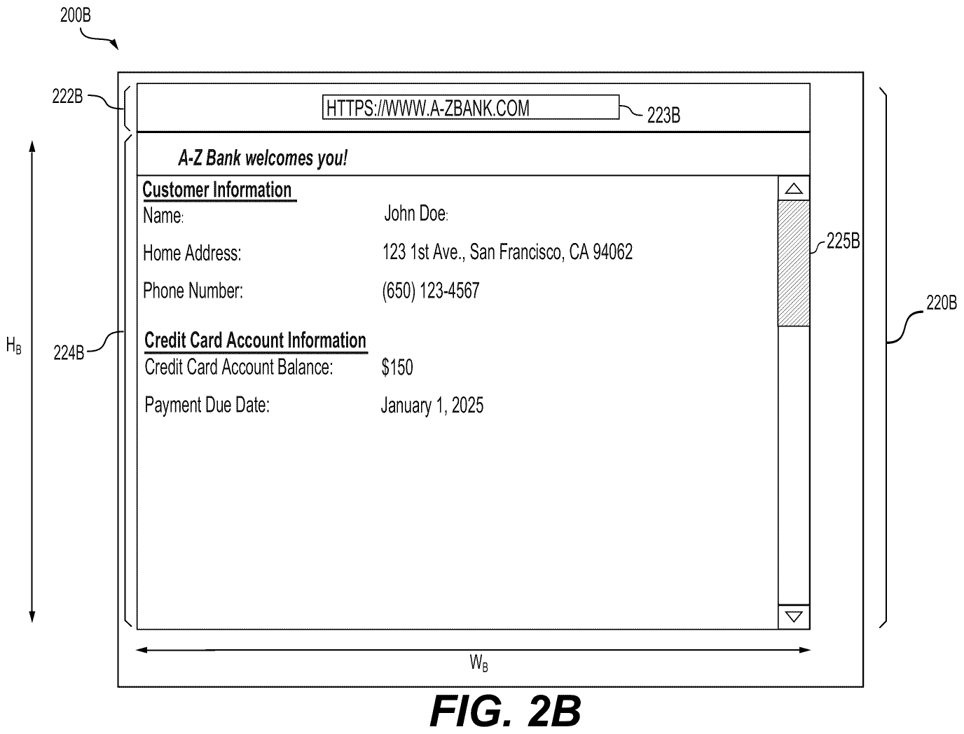

FIG. 2A depicts an example display screen 200A, according to one or more embodiments of the present disclosure. More specifically, FIG. 2A shows an example display screen 200A when the display screen 200A is not being screenshared or screenshotted. In some aspects, the display screen 200A may be an embodiment of the display 117. As shown in FIG. 2A, the display screen 200A may display a browser window 220A, which includes a region 222A and a viewport 224A. In some embodiments, the region 222A may have been outputted to the display screen 200A using the browser module 112, and the viewport 224A may have been outputted to the display screen 200A using the secure display path 115.

As shown in FIG. 2A, the region 222A includes a content element 223A, which may represent an address bar (or field) in which the web address (or uniform resource locator), https://www.A-ZBank.com, is entered. In some embodiments, the user 105 may be a customer of a bank called A-Z bank, and the user 105 may have entered the web address in the content element 223A to view the user 105's credit card balance on a webpage associated with A-Z Bank.

The viewport 224A displays a DRM-protected video that includes a single image frame representing (or depicting) the webpage associated with A-Z Bank. Because the display screen 200A is not being screenshared or screenshotted, the DRM-protected video is played in a loop in the viewport 224A. Consequently, the webpage of the DRM-protected video may appear as a still (or static) image to the user 105. In some embodiments, the user 105 may have had to log in to a website associated with A-Z Bank in order to view the webpage of the DRM-protected video on the display screen 200A. As shown in FIG. 2A, the webpage of the DRM-protected video includes the following content elements: (A) the greeting, “A-Z Bank welcomes you!;” (B) customer information of the user 105 including (i) the name, John Doe, (ii) the home address, 123 1^{st} Ave., San Francisco, CA 94062; and (iii) the phone number, (650) 123-4567; (C) credit card account information including (i) a credit card account balance of $150, and (ii) a payment due date of Jan. 1, 2025; and (D) a scrollbar 225A. In some aspects, the customer information and the credit card account information may represent sensitive data.

Further, in some aspects, the DRM-protected video may be presented (or played) in the viewport 224A in accordance with a first media query 113. The first media query 113 may specify, for example, (i) a media type of “screen” and (ii) a media feature of a viewport having a resolution of W_{A} pixels×H_{A} pixels (or a width of W_{A} pixels and a height of H_{A} pixels). Further, the first media query 113 may correspond to a first CSS rule specifying that a DRM-protected video associated with the webpage and presented in the viewport should have a resolution of W_{A} pixels×H_{A} pixels, and include an image frame with text data of size 12 font.

When the secure display path 115 initially loaded the DRM-protected video to the viewport 224A, the browser module 112 may have determined that the display screen 200A is a media type of “screen,” and that the viewport 224A has a resolution of W_{A} pixels×H_{A} pixels. The browser module 112 may have also determined that the first media query 113 evaluated to true (and thus is an operative media query), and subsequently applied the first CSS rule. To apply the first CSS rule, if the browser module 112 did not have access to a DRM-protected video that conformed with the first CSS rule on the user device 110, the browser module 112 may have retrieved such a DRM-protected video from the application server 125 in a manner described above with reference to FIG. 1. As shown in FIG. 2A, the DRM-protected video being played in the viewport 224A has a resolution of W_{A} pixels×H_{A} pixels and includes an image frame in which text data (e.g., the greeting, customer information, and credit card account information) are represented in size 12 font. Thus, because the DRM-protected video is presented in accordance with the first media query 113 (and the corresponding first CSS rule), the DRM-protected video and the text data therein are presented in a user-friendly manner. That is, the DRM-protected video and the text data therein fill the entire viewport 224A and are clear (or not distorted or cut off by the boundaries of the viewport 224A).

FIG. 2B depicts an example display screen 200B, according to one or more embodiments of the present disclosure. More specifically, FIG. 2B shows an example display screen 200B when the display screen 200B is not being screenshared or screenshotted. In some aspects, the display screen 200B may be an embodiment of the display screen 200A. As shown in FIG. 2B, the display screen 200B displays a browser window 220B, which includes a region 222B and a viewport 224B. In some aspects, the browser window 220B represents an enlarged version of the browser window 220A. That is, to view the browser window 220B, the user 105 may have used a mouse associated with the user device 110 to increase the size of the browser window 220A to that of the browser window 220B.

As shown in FIG. 2B, the browser window 220B includes a region 222B and a viewport 224B, which displays a DRM-protected video that includes a single image frame representing the webpage associated with A-Z bank. Because the display screen 200B is not being screenshared or screenshotted, the DRM-protected video is played in a loop in the viewport 224B. Thus, the webpage of the DRM-protected video may appear as a still image to the user 105. In some aspects, the DRM-protected video may be presented (or played) in the viewport 224B in accordance with a second media query 113. The second media query 113 may specify, for example, (ii) a media type of “display” and (ii) a media feature of a viewport having a resolution of WB pixels×HB pixels (or a width of WB pixels and a height of HB pixels). Further, the second media query 113 may correspond to a second CSS rule specifying that a DRM-protected video that is associated with the webpage and presented in the viewport should have a resolution of WB pixels×HB pixels, and include an image frame with text data of size 20 font.

When the secure display path 115 initially loaded the DRM-protected video to the viewport 224B, the browser module 112 may have determined that the display screen 200B is a media type of “display,” and that the viewport 224B has a resolution of WB pixels×HB pixels. The browser module 112 may have also determined that the second media query 113 evaluated to true (and thus is an operative media query), and subsequently applied the second CSS rule. To apply the second CSS rule, if the browser module 112 did not have access to a DRM-protected video that conformed with the second CSS rule on the user device 110, the browser module 112 may have retrieved such a DRM-protected video from the application server 125 in a manner described above with reference to FIG. 1. As shown in FIG. 2B, the DRM-protected video being played in the viewport 224B has a resolution of WB pixels×HB pixels and includes an image frame in which text data (e.g., the greeting, customer information, and credit card account information) are represented in size 20 font. Consequently, because the DRM-protected video is presented in accordance with the second media query 113 (and the corresponding second CSS rule), the DRM-protected video and the text data therein are presented in a clear, readable, and user-friendly manner.

It is noted that the DRM-protected videos and the respective content therein that are presented in FIGS. 2A and 2B are merely examples. In some embodiments, each of the viewports 224A and 224B of FIGS. 2A and 2B, respectively, may present multiple DRM-protected videos associated with the webpage. For example, the viewport 224A may present a DRM-protected video that includes an image frame representing the customer information, and another DRM-protected video that includes an image frame representing the credit card account information, or variations thereof.

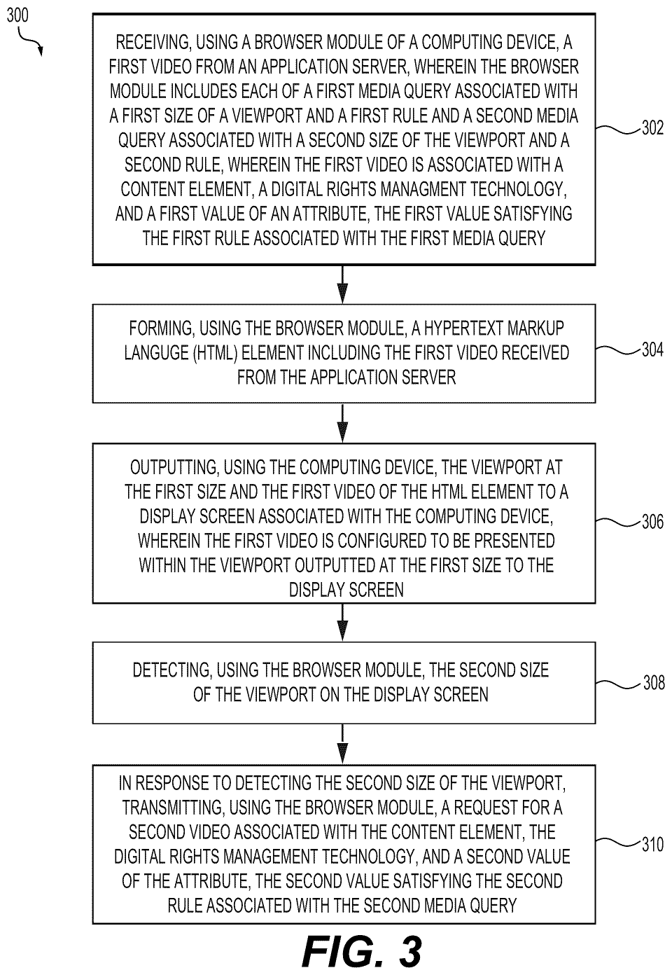

FIG. 3 depicts a flow diagram of an example method, according to one or more embodiments presented herein. More specifically, FIG. 3 depicts a flow diagram of a method 300 for securing content of a portal (e.g., a webpage, a website, an application, etc.) while maintaining fidelity of the content using media queries. In some aspects, the method 300 may be performed by the user device 110.

As shown in FIG. 3, the method 300 may include receiving, using a browser module (e.g., the browser module 112) of a computing device (e.g., the user device 110), a first video (e.g., the DRM-protected video of FIG. 2A) from an application server (e.g., the application server 125), wherein the browser module includes each of a first media query (e.g., a first media query 113) associated with a first size of a viewport and a first rule (e.g., a first CSS rule) and a second media query (e.g., a second media query 113) associated with a second size of the viewport and a second rule (e.g., a second CSS rule), where the first video is associated with a content element, a digital rights management technology, and a first value of an attribute, the first value satisfying the first rule associated with the first media query (302). In some aspects, the first size of the viewport may represent, for example, a specified width (e.g., W_{A} of FIG. 2A) or height (e.g., H_{A} of FIG. 2A) of a viewport. The second size of the viewport may represent a specified width (e.g., WB of FIG. 2B) or height (e.g., HB of FIG. 2B) of the viewport, but be different from the first size of the viewport. In some embodiments, the first CSS rule may be associated with an aspect ratio, a resolution, a height, a width, a type of layout, or a type of formatting. Further, the attribute may represent an aspect ratio, a resolution, a height, a width, a type of layout, or a type of formatting. The first value of the attribute may represent a number of pixels of the first video; a ratio (e.g., an aspect ratio) of the first video; a position of the first video; a position of the content element, where the content element is represented in an image frame of the first video; a font associated with the content element; or a font size associated with the content element. In some embodiments, the browser module may include a third media query (e.g., a third media query 113) associated with a third size of the viewport and a third rule (e.g., a third CSS rule).

In some embodiments, the first video may be configured to play in a loop, and the content element may represent sensitive data. Further, in some embodiments, the first video may include an image frame that represents the content element. In some other embodiments, the first video may include a transparent image frame configured to be overlaid on the content element on a display screen (e.g., the display 117) associated with the computing device. The first video may be configured to play on the display screen when the display screen is not being screenshared or screenshotted. The first video may also be configured to not play on the display screen when the display screen is being screenshared or screenshotted.

As shown in FIG. 3, the method 300 may include forming, using the browser module, a HyperText Markup Language (HTML) element including the first video received from the application server (304). In some embodiments, the HTML element may be included in an HTML page corresponding to a webpage, where the webpage may include the content element. In some embodiments, the webpage may also include the first video.

The method 300 may include outputting, using the computing device (e.g., the operating system module 114 or the browser module 112), the viewport at the first size (e.g., the viewport 224A) and the first video of the HTML element to the display screen associated with the computing device, where the first video is configured to be presented within the viewport outputted at the first size to the display screen (306). In some embodiments, the method 300 may include monitoring, using the browser module, a size of the viewport presented on the display screen. Further, the method 300 may include detecting, using the browser module, the second size of the viewport on the display screen (308).

The method 300 may further include, in response to detecting the second size of the viewport, transmitting, using the browser module, a request for a second video (e.g., the DRM-protected video of FIG. 2B) associated with the content element, the digital rights management technology, and a second value of the attribute, the second value satisfying the second rule associated with the second media query (310). In some embodiments, the method 300 may include using the browser module to receive the second video from the application server, and form an HTML element including the second video received from the application server. In some embodiments, the HTML element including the second video may be included in the HTML page corresponding to the webpage (and optionally replace the HTML element including the first video in the HTML page). The method 300 may further include outputting, using the computing device (e.g., the operating system module 114 or the browser module 112), the second video of the HTML element to the display screen, where the second video of the HTML element is configured to be presented within the viewport at the second size (e.g., the viewport 224B) of the display screen. In some embodiments, the method 300 may further include, in response to detecting the second size of the viewport, transmitting, using the browser module, a request for at least a third video, where the third video is associated with the content element, the digital rights management technology, and a third value of the attribute, the third value satisfying the third rule associated with the third media query.

In general, any process or operation discussed in this disclosure that is understood to be computer-implementable, such as the process (or method) illustrated in FIG. 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

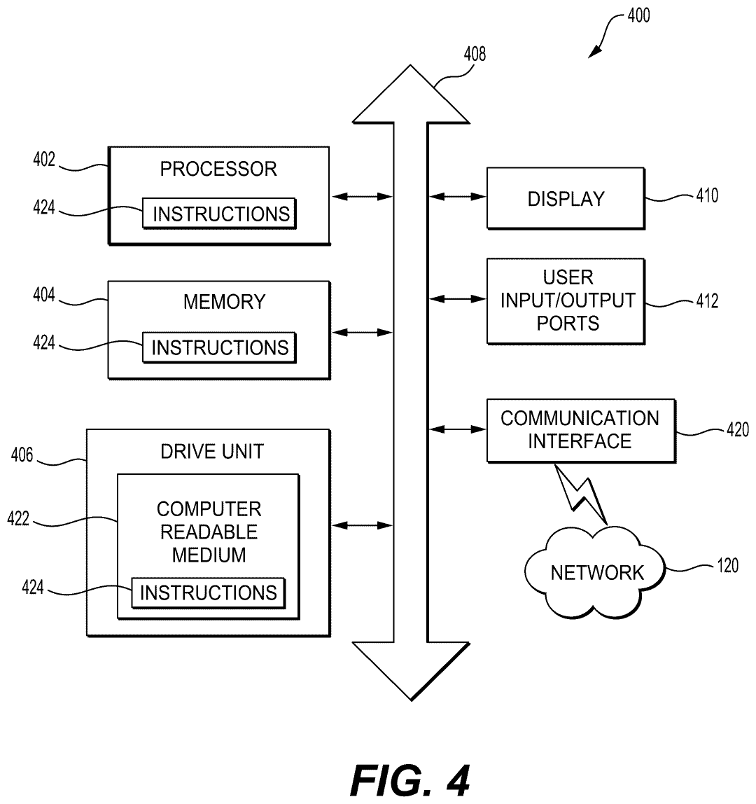

FIG. 4 is a simplified functional block diagram of a computer 400 that may be configured as a device for executing the method 300 of FIG. 3, according to exemplary embodiments of the present disclosure. For example, in some embodiments, the computer 400 may be configured as the user device 110, according to exemplary embodiments of this disclosure. In some other embodiments, the computer 400 may be configured as the application server 125, according to exemplary embodiments of this disclosure. In some other embodiments, the computer 400 may be configured as the CDM 130, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage (or drive) unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a browser module of a computing device, a first video from an application server, wherein the browser module includes each of a first media query associated with a first size of a viewport and a first rule and a second media query associated with a second size of the viewport and a second rule, wherein the first video is associated with a content element, a digital rights management technology, and a first value of an attribute, the first value satisfying the first rule associated with the first media query;
forming, using the browser module, a HyperText Markup Language (HTML) element including the first video received from the application server;
outputting, using the computing device, the viewport at the first size and the first video of the HTML element to a display screen associated with the computing device, wherein the first video is configured to be presented within the viewport outputted at the first size to the display screen;
detecting, using the browser module, the second size of the viewport on the display screen; and
in response to detecting the second size of the viewport, transmitting, using the browser module, a request for a second video associated with the content element, the digital rights management technology, and a second value of the attribute, the second value satisfying the second rule associated with the second media query.

2. The method of claim 1, further comprising:
receiving, using the browser module, the second video from the application server;
forming, using the browser module, an HTML element including the second video received from the application server; and
outputting, using the computing device, the second video of the HTML element to the display screen, wherein the second video of the HTML element is configured to be presented within the viewport at the second size on the display screen.

3. The method of claim 1, wherein the first rule represents a first Cascading Style Sheet (CSS) rule and the second rule represents a second CSS rule.

4. The method of claim 3, wherein the first CSS rule is associated with:
an aspect ratio;
a resolution;
a height;
a width;
a type of layout; or
a type of formatting.

5. The method of claim 1, wherein the attribute represents:
an aspect ratio;
a resolution;
a height;
a width;
a type of layout; or
a type of formatting.

6. The method of claim 1, wherein the first value of the attribute represents:
a number of pixels of the first video;
a ratio of the first video;
a position of the first video;
a position of the content element, wherein the content element is represented in an image frame of the first video;
a font associated with the content element; or
a font size associated with the content element.

7. The method of claim 1, wherein the browser module further includes a third media query associated with a third size of the viewport and a third rule, and wherein the method further includes:
in response to detecting the second size of the viewport, transmitting, using the browser module, a request for at least a third video, wherein the third video is associated with the content element, the digital rights management technology, and a third value of the attribute, the third value satisfying the third rule associated with the third media query.

8. The method of claim 1, further comprising:
monitoring, using the browser module, a size of the viewport presented on the display screen.

9. The method of claim 1, wherein the first video is configured to play on the display screen when the display screen is not being screenshared or screenshotted, and wherein the first video is configured to not play on the display screen when the display screen is being screenshared or screenshotted.

10. The method of claim 1, wherein the content element represents sensitive data.

11. The method of claim 10, wherein first video includes a transparent image frame configured to be overlaid on the content element on the display screen.

12. The method of claim 10, wherein first video includes an image frame that represents the content element.

13. The method of claim 1, wherein the first video is configured to play in a loop.

14. A system comprising:
at least one processor; and
at least one memory having programming instructions stored thereon, which, when executed by the at least one processor, cause the system to perform operations comprising:
receiving, using a computing device, a first video from an application server, wherein the computing device includes each of a first media query associated with a first size of a viewport and a first rule and a second media query associated with a second size of the viewport and a second rule, wherein the first video is associated with a content element, a digital rights management technology, and a first value of an attribute, the first value satisfying the first rule associated with the first media query;
forming, using the computing device, a HyperText Markup Language (HTML) element including the first video received from the application server;
outputting, using the computing device, the viewport at the first size and the first video of the HTML element to a display screen associated with the computing device, wherein the first video is configured to be presented within the viewport outputted at the first size to the display screen;
detecting, using the computing device, the second size of the viewport on the display screen; and
in response to detecting the second size of the viewport, transmitting, using the computing device, a request for a second video associated with the content element, the digital rights management technology, and a second value of the attribute, the second value satisfying the second rule associated with the second media query.

15. The system of claim 14, wherein the operations further comprise:
receiving, using a browser module of the computing device, the second video from the application server;
forming, using the browser module, an HTML element including the second video received from the application server; and
outputting, using the computing device, the second video of the HTML element to the display screen, wherein the second video of the HTML element is configured to be presented within the viewport at the second size on the display screen.

16. The system of claim 14, wherein the first rule represents a first Cascading Style Sheet (CSS) rule and the second rule represents a second CSS rule.

17. The system of claim 16, wherein the first CSS rule is associated with:
an aspect ratio;
a resolution;
a height;
a width;
a type of layout; or
a type of formatting.

18. The system of claim 14, wherein the attribute represents:
an aspect ratio;
a resolution;
a height;
a width;
a type of layout; or
a type of formatting.

19. The system of claim 14, wherein the first value of the attribute represents:
a number of pixels of the first video;
a ratio of the first video;
a position of the first video;
a position of the content element, wherein the content element is represented in an image frame of the first video;
a font associated with the content element; or
a font size associated with the content element.

20. A method comprising:
receiving, using a computing device, a first video from an application server, wherein the computing device includes each of a first media query associated with a first size of a viewport and a first rule and a second media query associated with a second size of the viewport and a second rule, wherein the first video is associated with sensitive data, a digital rights management technology, and a first value of an attribute, the first value satisfying the first rule associated with the first media query;
forming, using the computing device, a HyperText Markup Language (HTML) element including the first video received from the application server;
outputting, using the computing device, the viewport at the first size and the first video of the HTML element to a display screen associated with the computing device, wherein the first video is configured to be presented within the viewport outputted at the first size to the display screen;
detecting, using the computing device, the second size of the viewport on the display screen; and
in response to detecting the second size of the viewport, transmitting, using the computing device, a request for a second video associated with the sensitive data, the digital rights management technology, and a second value of the attribute, the second value satisfying the second rule associated with the second media query.
